(19) United States
(12) Patent Application Publication
(10) Pub. No.: US 2009/0031336 A1
(43) Pub. Date: Jan. 29, 2009

(54) GROUP PREFERENCE CONTROL SYSTEM

(76) Inventors: Timothy R. Chavez, Austin, TX (US); Jacob Daniel Eisinger, Austin, TX (US); Michael Charles Hollinger, Austin, TX (US); Jennifer Elizabeth King, Austin, TX (US); Christina Karen Lauridsen, Austin, TX (US); Fabian F. Morgan, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/781,988

(22) Filed: Jul. 24, 2007

(51) Int. Cl. H04N 7/173

(52) U.S. Cl. 725/24

(57) ABSTRACT

A method, medium and implementing computer system are provided in which the aggregate preferences of a gathered group of individuals in a certain proximity and with respect to a predetermined perceivable and controllable function are ascertained. Individual preferences are processed to obtain a group preference and if the group preference meets predetermined criteria, the group preference is implemented with respect to the controllable function. In a specific example, movie preview playlists are modified by a control server according to the ascertained preferences of the particular group to whom the movie previews are being presented. In another example, the ambient temperature of a room in which a group of individuals is gathered is adjusted by a temperature-control server in response to the polled and ascertained preferences of each of the individuals.

### FIELD OF THE INVENTION

The present invention relates generally to information processing systems and more particularly to a methodology and implementation for enabling participant control through group preference polling.

### BACKGROUND OF THE INVENTION

In every working and social environment, groups of individuals are gathering more frequently than ever before to accomplish common objectives. Such groups include, for example, working groups gathered for work-related presentations and social groups such as movie-goers gathered to view a movie presentation. In all of these situations, there are variables which are part of the common experience. Many times, however, a portion of the individuals of the gathered group would prefer to change one or more of the variable factors in the group environment. For example, in many gatherings, the ambient temperature is a variable that can be controlled but is usually pre-set to a fixed setting. In such situations, it would be helpful to be able to determine whether or not the pre-set temperature is comfortable for the majority of the participants especially for conferences where presentations continue for an extended period of time, and to be able to adjust the area temperature according to the desires of a substantial majority of the participants.

In a similar application, where a group is gathered to view a movie, for example, it would not only be desirable to control the ambient temperature, but also where presentation content such as specific movie previews, which are typically presented before the main feature, may not be of particular interest to all of the movie-goers, it would be desirable to be able to determine which previews are more important to most of the individuals present in the movie theater. It would also be desirable to be able to accommodate the desires of the majority of the participants with respect to the preview content being presented.

More specifically, at present, movie theaters show previews without taking the current viewership's aggregate movie preferences into account. For example, a preview for a horror movie, a comedy, and a romantic-themed movie may be shown when 80% of the current viewership may have a strong inclination towards action movies, and hence may be less interested in the previews that were shown. What is needed, therefore, is a means of assessing the current viewership's preferences and selecting the previews shown according to the profiles developed.

Thus there is a need for an improved methodology and system for ascertaining group preferences of groups of individuals gathered for common events and automatically accommodating such preferences at such events.

### SUMMARY OF THE INVENTION

A method, medium and implementing computer system are provided in which the aggregate preferences of a gathered group of individuals in a certain proximity and with respect to a predetermined perceivable and controllable function are ascertained. Individual preferences are processed to obtain a group preference and if the group preference meets predetermined criteria, the group preference is implemented with respect to the controllable function. In an exemplary embodiment, user input devices such as Bluetooth-enabled devices having input and display capabilities, are implemented to transmit user preferences to a control server which, in turn, analyzes the user inputs and adjusts a common group variable accordingly. In a specific example, movie preview playlists are modified by a control server according to the ascertained preferences of the particular group to whom the movie previews are being presented. In another example, the ambient temperature of a room in which a group of individuals is gathered is adjusted by a temperature-control server in response to the polled and ascertained preferences of each of the individuals.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one environment in which the present invention may be implemented;

FIG. 2 is a block diagram showing several of the major components of a user input device which may be implemented in accordance with the present invention; and

FIG. 3 is a flow chart illustrating an operation of the present invention in the FIG. 1 example.

### DETAILED DESCRIPTION

The various methods discussed herein may be implemented within a typical computer system which includes processing means, memory, updateable storage, input means and display means, and communication means, including the Bluetooth communication protocol, for communicating information between individual user systems and a central server system accessible by users of the system. Since the individual components of a computer system which may be used to implement the computer functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Further, although the invention is illustrated using an example of a movie theater environment, it is understood that the principles taught herein apply equally well in many other environments, including but not limited to classrooms in which students are gathered, display presentations of retail or other current or future products, and all group situations where temperature or light or other environmental common factor is a controllable element.

In general, an exemplary method for ascertaining an aggregate group preference profile is illustrated by the following movie theater example. A Bluetooth transmitter and storage device is installed in each of the theater rooms. During the movie preview phase, as viewers enter the room, the transmitter broadcasts a message to all Bluetooth-enabled user devices within the room. Alternately, the user input devices may be pre-installed at seating locations throughout the room where the viewers will be seated. The message prompts the recipient if they would like to receive a software download (if they don't have it already) that allows them to essentially assess the ongoing movie previews and specify their preferences. After the viewer accepts the software download and installs it, the transmitter transfers a small survey to the Bluetooth device at the end of each movie preview. Sample questions may include, for example:

1. Would you go and see the movie XYZ whose preview was just shown? a) Yes b) No c) I might.

1.1. If no to question 1—What reason below best summarizes why you would not see the movie? a) I don't like movies of that genre b) The plot is not intriguing c) It seems silly d) Preview gave away too much of the movie e) Other.

2. Are any of your favorite actors/actresses in the movie? If so, please select: a) Actor A b) Actor B c) Actress C, etc.

The surveys or poll questions rely on multiple-choice answers to minimize discomfort for the user; however, viewers are also enabled to fill out free-text responses using the keypad for their Bluetooth device. The survey responses of each viewer could be sent back to the transmitter/control server after each assessment, or could be sent back in batch after they fill out all assessments.

The survey data responses are collected and processed on the Bluetooth storage device or control server. Optionally, the responses could be sent to a central server, either locally or over an Internet connection, for further data analysis. After the viewer fills out a certain threshold of assessments, a profile of their collective preferences is automatically generated by the downloaded software, based on previous responses. This profile is then used for dynamically selecting the movie previews to show.

One example of the method for dynamically selecting which movie previews to show involves the following sequence of steps. The methodology will be in use over time, so that after a while, a sufficient amount of viewers would have performed enough assessments for a profile to be created on their Bluetooth device. This method takes the number of profiles created into account, so that a minimum number of users (for example 20) need to have a profile created in a given movie theater room for the dynamic movie preview selection to occur. Assuming the criterion above is met, the Bluetooth transmitter requests the profile for each viewer and performs an “On Demand” calculation of the aggregate preferences. The theater utilizes this calculation in the selection of which movie preview to show next. As noted below, this can be accomplished automatically using a preview playlist accessing a library of possible movie previews. Note that this pre-supposes the existence of a database of movie previews to show, along with associated metadata such as actors involved, movie genre, etc. For example, if the On Demand calculation was that 50% prefer movies with Actor A, 45% prefer action movies, and 40% prefer movies that are less than 90 minutes, then the movie preview selection component would first search to see if there is an upcoming movie with Actor A in it. If there is, it would check if there are any action movies with Actor A, or shorter movies with Actor A. If there were no upcoming movies with Actor A, it would search for action movies, and so on. The movie previews are shown in prioritized order. Note that it is possible that no definite correlations can be made for a given viewership. In this case, the movie theater could resort to showing a default playlist of previews as it currently does today. An alternative, more rudimentary solution would be to simply give the viewers the choice of which preview to see, and have them vote using their Bluetooth-enabled devices. The voting process could give them a time window to submit votes.

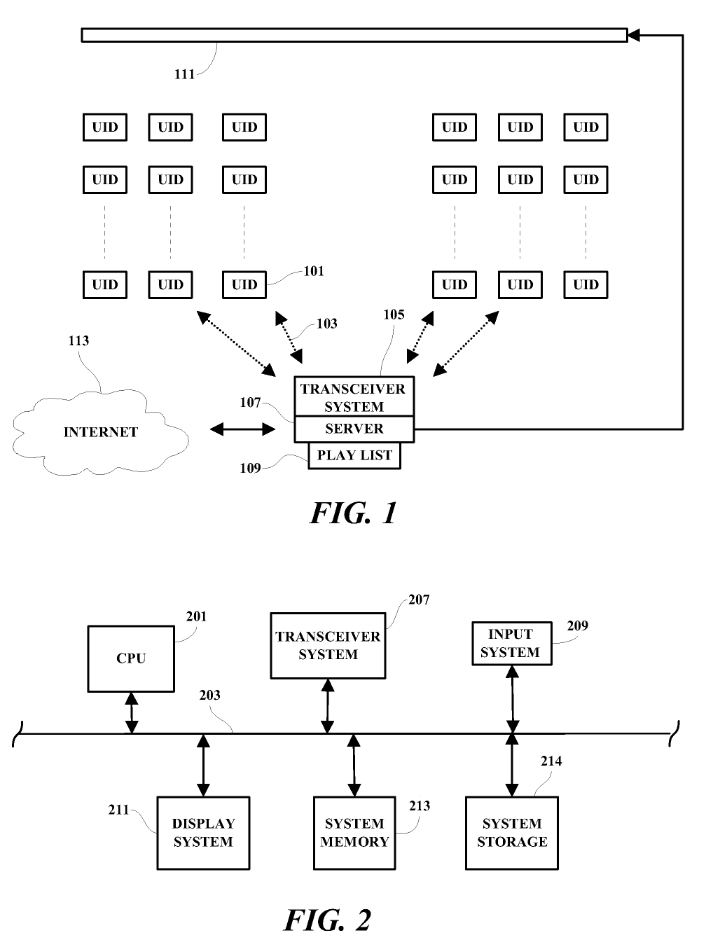

With specific reference to FIG. 1, there is shown a plurality of user input devices (UID) 101, each with a Bluetooth capability arranged to communicate 103 with a transceiver system 105. In an alternate embodiment, the UIDs 101 may be hardwired into individual locations where users may be seated. Each of the UIDs includes a device display for selectively presenting questions and instructions to each user, and for receiving user input and comments with regard to questions and/or instructions presented on the device displays. The user input and comments are transmitted to a central transceiver system 105 which is coupled to a control server 107. The control server is operable to receive and process the user inputs from the UIDs 101. The control server includes a processing system including memory, storage, input means and an output system which are not specifically shown in the drawing. The output from the control server is operable for controlling the content of presentations displayed on a group display screen 111 which is viewable by all of the individuals having the UID's 101. In the example, the control server 107 is controlling the presentation of movie previews for example, from a Playlist 109 being accessed from the server memory. The control server 107 is also operable to modify the items contained in the Playlist 109 in response to the inputs received from the UIDs 101. The control server 107 may also be coupled to an interconnection network such as the Internet 113 for access to other servers and information systems.

FIG. 2 shows several of the major components within the UIDs 101 illustrated in FIG. 1. As shown, the UIDs include, inter alia, a processing system or central processing unit (CPU) 201 which is coupled to a main bus 203. Also coupled to the bus 203 are a transceiver system 207, a user input system 209 which may be a keypad, mini-keyboard or stylus, a device display system 211, system memory 213 and system storage 214. In an alternate embodiment, the display system 211 may be a touch-sensitive screen which would provide another means by which user input can be provided to the control server 107. The main bus 203 may also be coupled to other systems and/or interfaces, such as a network interface, to provide enhanced system operation.

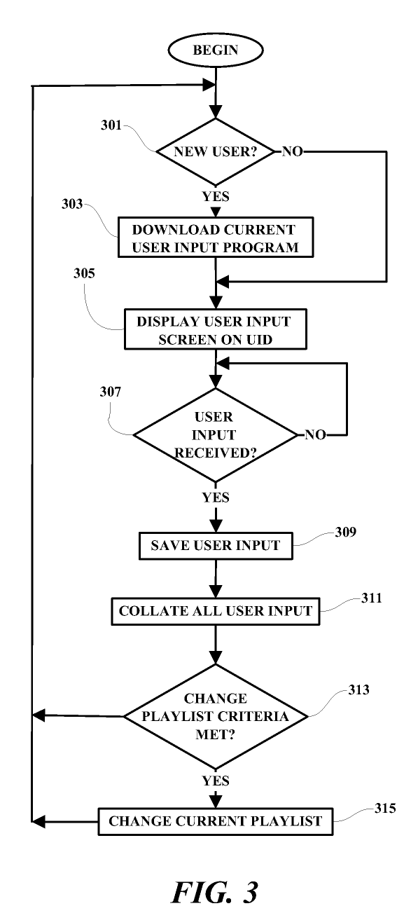

As shown in the FIG. 3 flowchart, when a new user is detected 301, such as when a new user obtains a UID and powers on the UID, the current user input program is downloaded 303 from the control server 107 and a user input screen is displayed 305 on the device display 211. The user input screen contains the questions and/or instructions to the user as hereinbefore explained. The user will use the input system 209, whether it be keypad, stylus or other, to answer the questions presented on the device display and to provide comments as appropriate. Upon completion of each input segment, the user will make a selection to indicate that his input is ready to be transmitted to the control server 107 for analysis. When the user input is received 307 it is saved 309 and processed and/or collated 311 by the control server with the inputs from all of the other user inputs received from the particular assembled group having UIDs 101. Depending upon the criteria programmed into the server 107, if user input indicates that a change is desired 313, action is taken to respond to the user input and dynamically make a change 315 to accomplish a desired action. For example, if 80% or more of the user inputs indicate that the viewers prefer to see action movie previews, then the control server will delete non-relevant movie previews from the Playlist 109 and substitute therefor action movie previews such that the particular assembled group is presented with the previews as preferred by most of the viewers.

The system illustrated in FIG. 1 may also be used to control the temperature of the presentation room. A questionnaire is presented on the device display for example to ascertain if the current room temperature is comfortable and if not, whether the set temperature should be increased or decreased. This input will be made during a limited window period in order to get a current consensus in order to change the room temperature setting one time without continually increasing and decreasing the temperature to suit particularly sensitive needs of only a few individuals in the group. For example, 60% or 70% of a group must indicate a desire for a higher temperature before the room temperature setting is increased.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical or magnetic memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing individual preferences of individuals in a group of individuals within a predetermined area, said individual preferences being with respect to a controllable function perceivable by said group of individuals, said method comprising:
polling said individuals to obtain said individual preferences with respect to said controllable function;
sending information descriptive of said individual preferences to a main processing system;
correlating said individual preferences to obtain an indication of a group preference with regard to said controllable function; and
automatically modifying said controllable function in accordance with said group preference.

2. The method as set forth in claim 1 wherein said controllable function is changed if a percentage of individuals of said group indicating said group preference exceeds a predetermined percentage.

3. The method as set forth in claim 1 wherein said controllable function is air temperature within said predetermined area.

4. The method as set forth in claim 1 wherein said controllable function is a presentation of a series of video files displayed to said group on a central display screen.

5. The method as set forth in claim 1 wherein said polling is accomplished by providing each of said individuals with a user input device, said user input device having a device display and user input means.

6. The method as set forth in claim 5 and further including displaying a polling questionnaire related to said controllable function on each of said user input devices and enabling said individuals to input said individual preferences relative to said controllable function in response to said polling questionnaire.

7. The method as set forth in claim 5 wherein said main processing system is a control server and said user input devices send said information describing said individual preferences to said control server over a hard-wired communication system.

8. The method as set forth in claim 5 wherein said main processing system is a control server and said user input devices send said information describing said individual preferences to said control server over a wireless communication system.

9. The method as set forth in claim 8 wherein said predetermined area is a movie theater, said individuals being polled to determine preferences of said individuals with respect to a type of movie preview being presented to said group in said movie theater.

10. The method as set forth in claim 4 wherein said main processing system is operable to change video files on a playlist of scheduled video files in response to said group preference.

11. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being selectively operable for processing individual preferences of individuals in a group of individuals within a predetermined area, said individual preferences being with respect to a controllable function perceivable by said group of individuals, said program signals being further operable for:
effecting a polling said individuals to obtain said individual preferences with respect to said controllable function;
sending information descriptive of said individual preferences to a main processing system;
correlating said individual preferences to obtain an indication of a group preference with regard to said controllable function; and
automatically modifying said controllable function in accordance with said group preference.

12. The medium as set forth in claim 11 wherein said controllable function is changed if a percentage of individuals of said group indicating said group preference exceeds a predetermined percentage.

13. The medium as set forth in claim 11 wherein said controllable function is air temperature within said predetermined area.

14. The medium as set forth in claim 11 wherein said controllable function is a presentation of a series of video files displayed to said group on a central display screen.

15. The medium as set forth in claim 11 wherein said polling is accomplished by providing each of said individuals with a user input device, said user input device having a device display and user input means.

16. The medium as set forth in claim 15 wherein said program signals are further effective for displaying a polling questionnaire related to said controllable function on each of said user input devices and enabling said individuals to input said individual preferences relative to said controllable function in response to said polling questionnaire.

17. The medium as set forth in claim 15 wherein said main processing system is a control server and said user input devices send said information describing said individual preferences to said control server over a hard-wired communication system.

18. The medium as set forth in claim 15 wherein said main processing system is a control server and said user input devices send said information describing said individual preferences to said control server over a wireless communication system.

19. The medium as set forth in claim 18 wherein said predetermined area is a movie theater, said individuals being polled to determine preferences of said individuals with respect to a type of movie preview being presented to said group in said movie theater.

20. A processing system operable to process individual preferences of individuals in a group of individuals within a predetermined area, said individual preferences being with respect to a controllable function perceivable by said group of individuals, said system comprising:
means for polling said individuals to obtain said individual preferences with respect to said controllable function;
means for sending information descriptive of said individual preferences to a main processing system;
means for correlating said individual preferences to obtain an indication of a group preference with regard to said controllable function; and
means for automatically modifying said controllable function in accordance with said group preference.
